(19) United States
(12) Patent Application Publication
(10) Pub. No.: US 2018/0279431 A1
(43) Pub. Date: Sep. 27, 2018

(54) DRIVE CIRCUIT

(71) Applicant: Infineon Technologies Austria AG, Villack (AT)

(72) Inventors: Marcus Schaemann, Munich (DE); Tiam Poh Lau, Singapore (SG)

(21) Appl. No.: 15/934,287

(22) Filed: Mar. 23, 2018

(30) Foreign Application Priority Data
Mar. 27, 2017 (DE) 102017106503.2

(51) Int. Cl. H05B 33/08; H02M 3/335; H02M 1/08

(52) U.S. Cl. CPC H05B 33/0815; H02M 3/33523; H02M 2001/0009; H05B 33/0845; H02M 1/08

(57) ABSTRACT

A drive circuit and a method are disclosed. The drive circuit includes output nodes configured to be coupled to a load, a capacitor coupled between the output nodes, and a power converter. The power converter is configured to store an initialization value in a memory in at least one of a plurality of on-phases of the drive circuit and to control an initialization phase of at least one other of the plurality of on-phases based on the initialization value stored in the memory. The initialization value is dependent on an output voltage across the capacitor during a load drive phase of the at least one on-phase, and the power converter is further configured to regulate an output current during the load drive phase.

This disclosure in general relates to a drive circuit, in particular a drive circuit for driving an LED circuit with at least one emitting diode (LED).

Some types of lamp drive circuits for LEDs include a switched-mode power converter configured to generate a regulated output current. “Regulated” in this context means that an average level of the output current over one or more cycles of a switched-mode operation of the power converter is regulated. By virtue of the switched-mode operation, however, an instantaneous level of the output current may vary. In order to prevent that those variations cause the LED(s) to flicker an output capacitor may be connected between output nodes of the power converter and in parallel with the LED circuit. Such capacitor, however, causes a delay time between a time instance when the power converter starts to operate and generates an output current and a time instance when the LED begins to illuminate. The reason is that before the at least one LED illuminates the output capacitor has to be charged by the current provided by the power converter to a voltage level that essentially equals a forward voltage of the LED circuit.

There is a need to reduce this delay time, which may also be referred to as time-to-light.

One example relates to a drive circuit. The drive circuit includes output nodes configured to be coupled to a load, a capacitor coupled between the output nodes, and a power converter. The power converter is configured to store an initialization value in a memory in at least one of a plurality of on-phases of the drive circuit and to control an initialization phase of at least one other of the plurality of on-phases based on the initialization value stored in the memory. The initialization value is dependent on an output voltage across the capacitor during a load drive phase of the at least one on-phase, and the power converter is further configured to regulate an output current during the load drive phase.

Another example relates to a method. The method includes in at least one of a plurality of on-phases of a drive circuit storing an initialization value in a memory, controlling an initialization phase of the drive circuit during at least one other of the plurality of on-phases based on the initialization value stored in the memory, and regulating an output current during the at least one other on-phase after the initialization phase. The initialization value is dependent on an output voltage across an output capacitor of the drive circuit during a load drive phase of the at least one on-phase.

Examples are explained below with reference to the drawings. The drawings serve to illustrate certain principles, so that only aspects necessary for understanding these principles are illustrated. The drawings are not to scale. In the drawings the same reference characters denote like features.

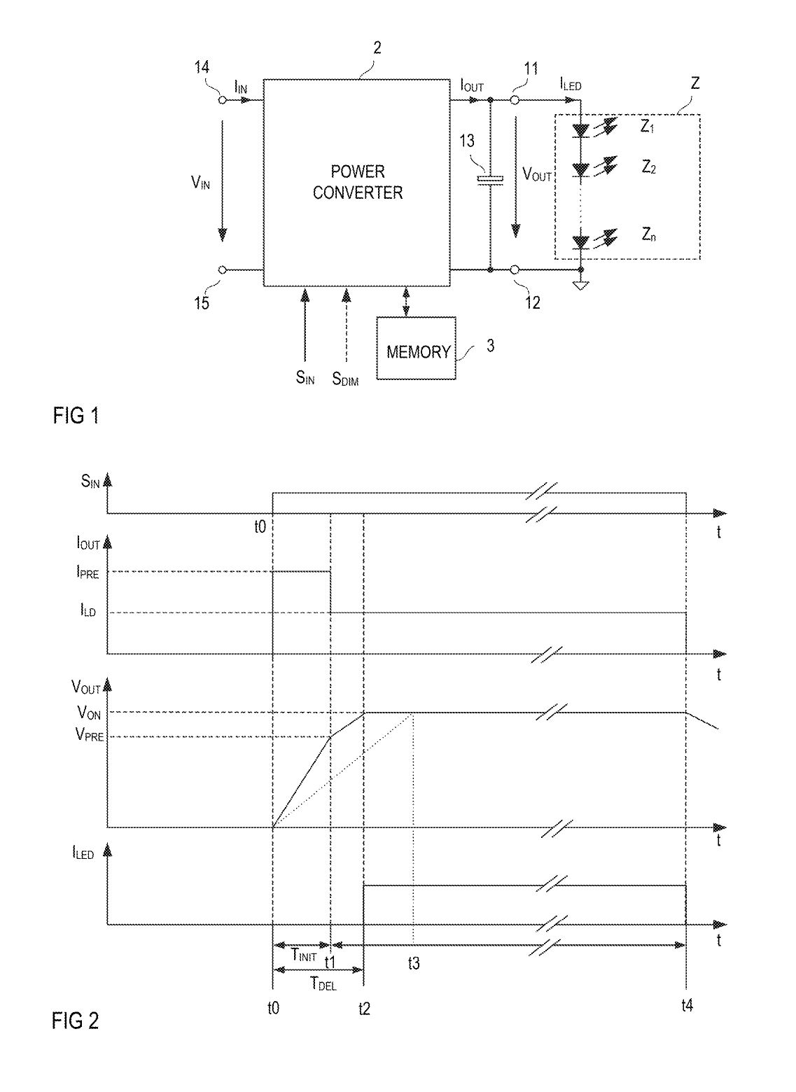

FIG. 1 schematically illustrates a lamp drive circuit according to one example;

FIG. 2 shows timing diagrams of signals occurring in the lamp drive circuit shown in FIG. 1 during one on-phase;

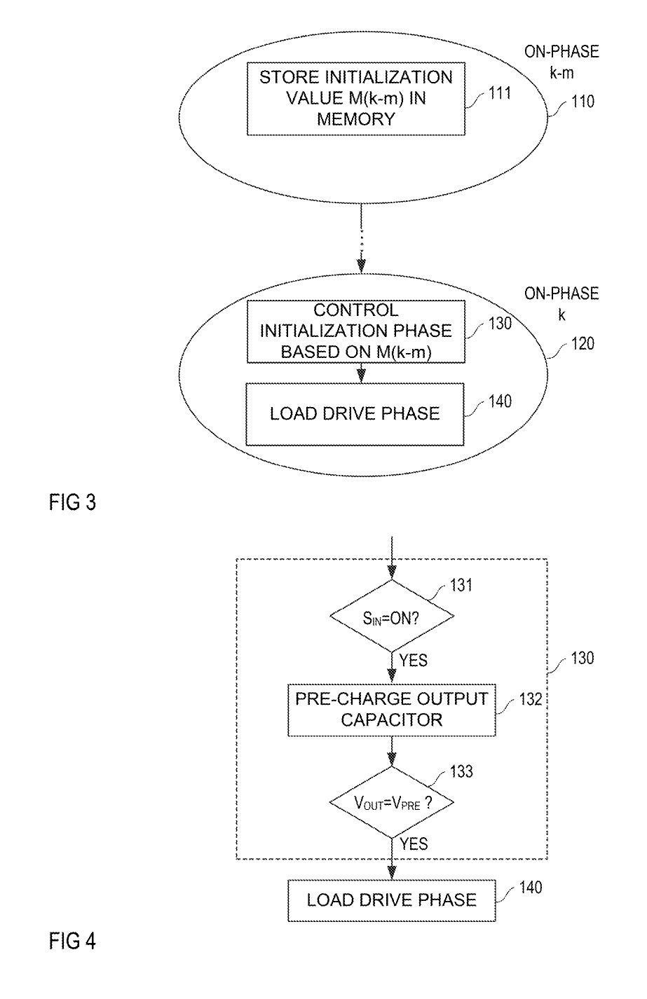

FIG. 3 illustrates one example of a method for operating the lamp drive circuit in two different on-phases;

FIG. 4 illustrates an example of one of the process steps shown in FIG. 3 in greater detail;

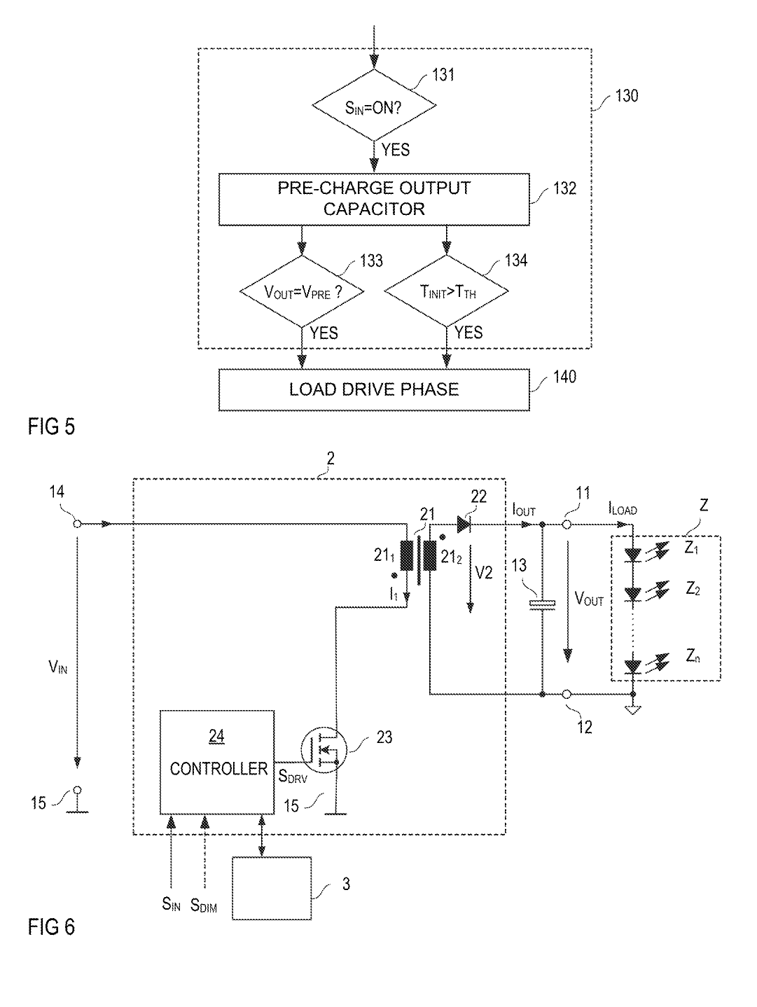

FIG. 5 illustrates a modification of the process step illustrated in FIG. 4;

FIG. 6 shows one example of a power converter circuit of the lamp drive circuit;

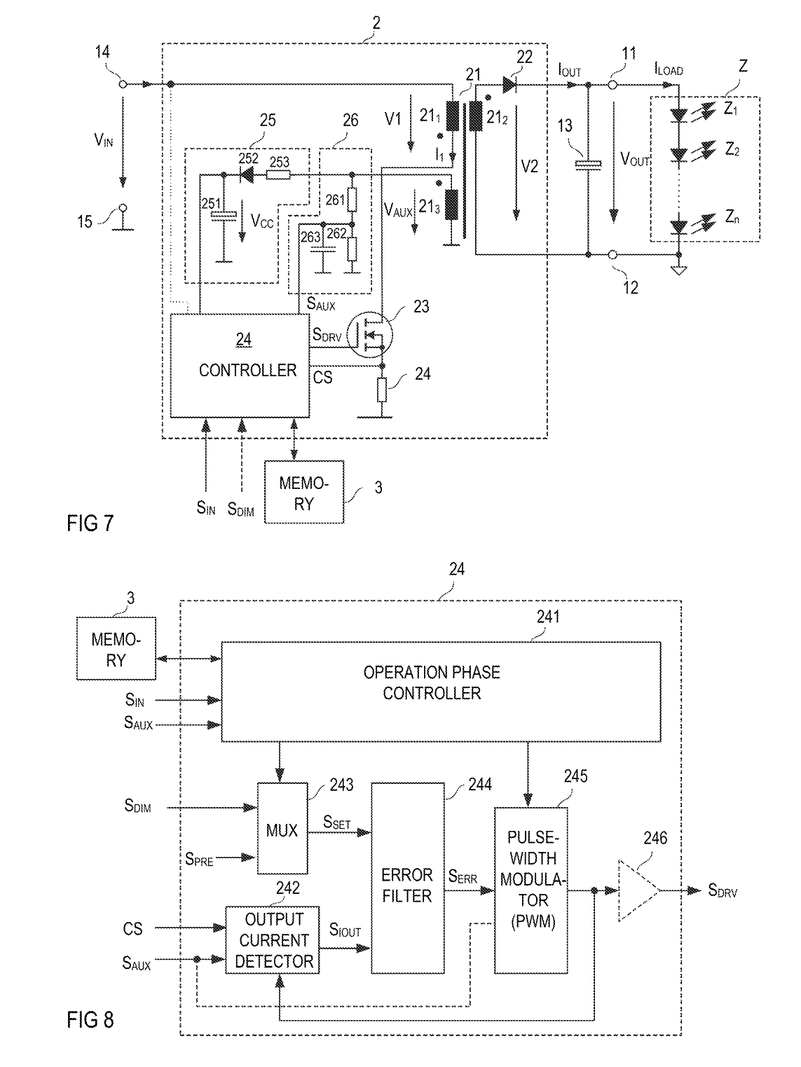

FIG. 7 shows another example of the power converter circuit of the lamp drive circuit;

FIG. 8 shows one example of a controller shown in FIG. 7;

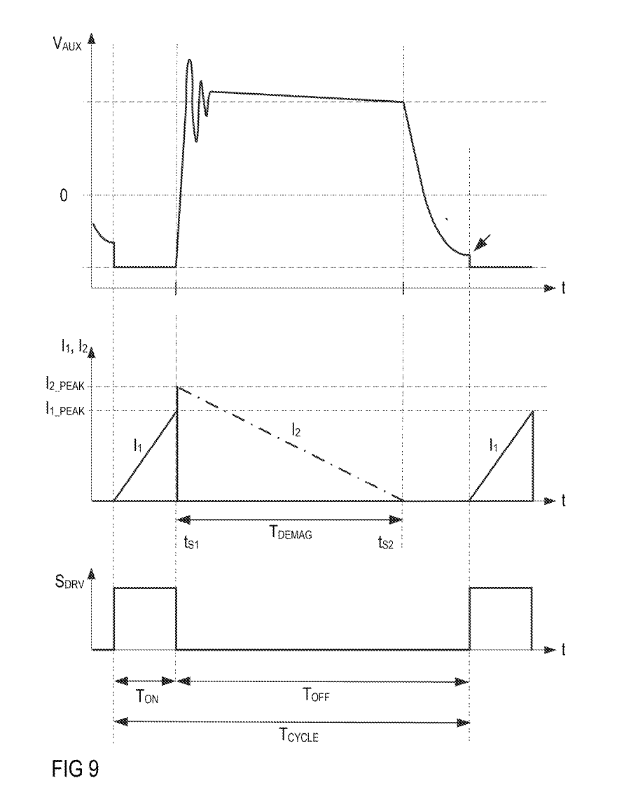

FIG. 9 shows timing diagrams of signals occurring in the lamp drive circuit shown in FIG. 7 during one drive cycle of a switched-mode operation of the power converter; and

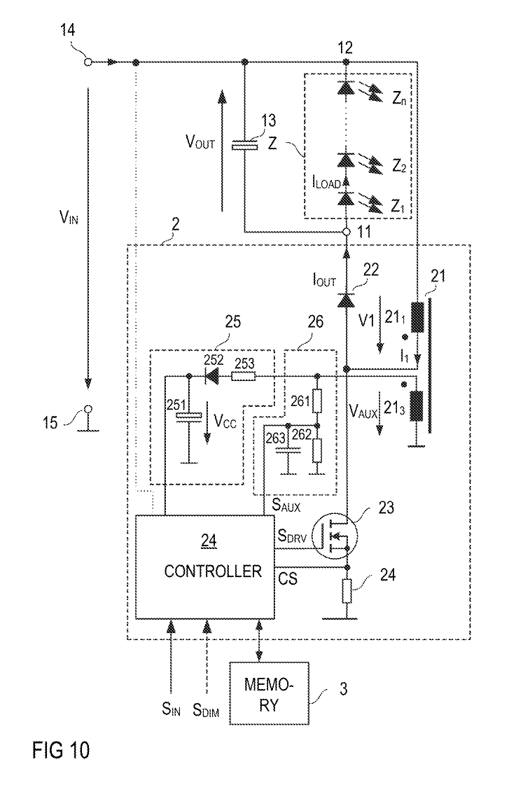

FIG. 10 shows another example of the power converter of the lamp drive circuit.

In the following detailed description, reference is made to the accompanying drawings. The drawings form a part of the description and for the purpose of illustration show examples of how the invention may be used and implemented. It is to be understood that the features of the various embodiments described herein may be combined with each other, unless specifically noted otherwise.

FIG. 1 shows one example of a lamp drive circuit. This lamp drive circuit includes an output with a first output node 11 and a second output node 12 and a power converter 2. The power converter is connected between an input with input nodes 14, 15 and the output 11, 12. The output 11, 12 is configured to have a load connected thereto. Further, an output capacitor 13 is connected between the output nodes 11, 12 and parallel to the load, if there is any. In particular, the lamp drive circuit shown in FIG. 1 configured to drive an LED (light emitting diode) circuit Z that includes at least one Z₁-Zₙ. Just for the purpose of illustration, the LED circuit Z shown in FIG. 1 includes an LED series circuit with n LEDs connected in series. Just for the purpose of illustration, n=3 in the example shown in FIG. 1.

The lamp drive circuit is configured to operate in an on-phase or an off-phase dependent on an input signal S_{IN} received by the power converter 2. In the on-phase, the power converter 2 receives input power from a power source (not shown) coupled to the input 14, 15 and generates an output current I_{OUT} based on the input power. The input power received by the power converter 2 is given by an input voltage V_{IN} multiplied by an input current I_{IN}. According to one example, the input voltage V_{IN} is a direct voltage. Such direct voltage may be provided by a DC power source. Alternatively, there is an AC power source, such as an AC power grid, and a rectifier circuit (not shown) generates the input voltage V_{IN} based on an AC voltage provided by the AC power source. The rectifier circuit may include an active rectifier circuit such as a boost converter with a PFC (power factor correction) capability, or may include a passive rectifier circuit such as a bridge rectifier and a capacitor connected between the input nodes 14, 15.

According to one example, the power converter 2 is a switched-mode power converter. The power converter 2 shown in FIG. 1, when implemented as a switched mode power converter, can regulate the output current I_{OUT} such that an average current level in individual operation cycles is substantially constant. However, within one operation cycle the current level may vary by virtue of the switched-mode operation of the power converter 2. An intensity of light emitted by each of the LEDs Z₁-Zₙ shown in FIG. 1 is dependent on a load current LED flowing through the LED circuit Z. If the output capacitor 13 would be omitted the load current I_{LED} would be equal the output current I_{OUT} of the power converter 2. In this case, however, a varying current level of the output current I_{OUT} may cause the LEDs to flicker or even being damaged. The output capacitor 13 serves to stabilize the load current LED, that is, to suppress current ripples resulting from the switched-mode operation or at least reduce those current ripples such that flickering is reduced and there is no risk of the LED circuit getting damaged. At the beginning of the on-phase, however, the output capacitor 13 has to be charged by the output current I_{OUT} of the power converter 2 before the LEDs Z₁-Z₂ can illuminate. A voltage level the output voltage V_{OUT} across the output capacitor 13 has to reach before the LEDs Z₁-Zₙ illuminate is essentially dependent on the number of LEDs Z₁-Zₙ connected in series and the forward voltage of the individual LEDs Z₁-Zₙ. As a rule of thumb, the required output voltage V_{OUT} is given by the number n of LEDs Z₁-Zₙ multiplied with the forward voltage of one LED. After the output capacitor 13 has been charged to this voltage level, the load current I_{LED} substantially equals an average of the output current I_{OUT}, so that in this operation phase an intensity of the light emitted by the LEDs Z₁-Z₂ can be controlled by regulating the output current I_{OUT}.

Referring to the above, the on-phases and off-phases of the lamp drive circuit are dependent on the input signal S_{IN}. This input signal S_{IN} may be generated in various ways by an input device that can be operated by a user. Examples of such input devices include, but are not restricted to, a light switch, a remote control, a movement sensor, a smart phone, or the like. A duration of the on-phases and the off-phases may range from between several seconds or several minutes to several hours or even several days. During the off-phases, the output capacitor 13 discharges due to leakage currents in the LED circuit Z or the capacitor 13. Thus, the output capacitor 13 (at least partially) needs to be charged at the beginning of each on-phase. This charging of the output capacitor 13 causes a delay between the beginning of the on-phase and the time, when the LEDs begin to illuminate. The beginning of the on-phase is when the input signal S_{IN} indicates that it is desired to switch on the LED circuit Z with the LEDs Z₁-Zₙ. A duration of this delay is sometimes referred to as time-to-light.

In order to achieve a short delay time, the power converter circuit 2 is configured to pre-charge the output capacitor 13 during an initialization phase at the beginning of the on-phase based on an initialization value. According to one example, pre-charging the output capacitor 13 includes generating the output current I_{OUT} by the power converter 2 with an average current level that is higher than the current level of the load current I_{LED} required by the LEDs. This is illustrated in FIG. 2, in which timing diagrams of the input signal S_{IN}, the output current I_{OUT}, the output voltage V_{OUT} and the load current LED are illustrated during one on-phase. The current level of the output current I_{OUT} illustrated in FIG. 2 is an average current level, so that current ripples resulting from a switched-mode operation of the power converter 2 are not illustrated. Further, the timing diagrams shown in FIG. 2 schematically illustrate the operation of the lamp drive circuit so that propagation delays in the power converter circuit 2, such as a delay between a beginning of the on-phase and an instance when the output current I_{OUT} starts to flow are not illustrated.

Referring to FIG. 2, a beginning of the on-phase at a time t0 is defined by the input signal S_{IN}. At this time t0, the input signal S_{IN} changes from an off-level to an on-level. The off-level indicates that it is desired to switch off the LED circuit Z, that is, to operate the lamp drive circuit in the off-state. The on-level indicates that it is desired to switch on the LED circuit Z, that is, to operate the lamp drive circuit in the on-state. Just for the purpose of illustration, the on-level is drawn as a high signal level and the off-level is drawn as a low signal level in the example shown in FIG. 2. In the example shown in FIG. 2, the on-phase ends at time t4 when the input signal S_{IN} changes from the on-level to the off-level.

Referring to FIG. 2, an initialization phase begins at the beginning of the on-phase. A duration of the initialization phase is referred to as T_{INIT} in FIG. 2. During the initialization phase, the power converter circuit generates the output current I_{OUT} with a pre-charge level I_{PRE} which can be higher than a lamp drive level I_{LD} after the initialization phase. An operation phase of the lamp drive circuit after the initialization phase and until the end of the on-phase is referred to as lamp drive phase in the following. According to one example, the pre-charge level I_{PRE} is fixed. This pre-charge level may be defined during or at the end of the manufacturing process of the power converter 2. According to another example, the power converter adjusts the pre-charge level during or after a very first on-phase based on the lamp drive level I_{LD} occurring in the very first on-phase. In the very first on-phase, the pre-charge level may be based on a value stored in the power converter during or at the end of the manufacturing process. According to yet another example, the pre-charge level I_{PRE} can be programmed via a programming interface (not shown in FIG. 1) at the installation site by an electrician, for example. The lamp drive level I_{LD} may be fixed or may be defined by a dim signal S_{DIM} (illustrated in dashed lines in FIG. 1) received by the power converter 2. This dim signal S_{DIM} which may define the intensity of the light emitted by the LEDs may be generated by the same input device operated by the user and generating the input signal S_{IN}. According to another example, the pre-charge level I_{PRE} is dependent on the lamp drive level I_{LD}. That is, the power converter 2 adjusts the pre-charge level I_{PRE} such that it is a predefined multiple of the lamp drive level I_{LD}, wherein the lamp drive level I_{LD} may be adjusted by the dim signal. In each case, the pre-charge level I_{PRE} may be generated such that a ratio between the pre-charge level I_{PRE} and the load drive level is selected from, for example, between 1.5:1 and 5:1, in particular between 2:1 and 4:1.

In FIG. 2, V_{ON} denotes a voltage level of the output voltage V_{OUT} at which the LEDs Z₁-Zₙ switch on, that is, V_{ON} denotes a voltage at which the output voltage V_{OUT} is high enough to operate the individual LEDs Z₁-Zₙ in a light emitting mode. At this time, the load current I_{LED} increases to a current level that essentially equals the lamp drive level I_{LD} of the output current I_{OUT}. A time duration T_{DEL} between the beginning of the on-phase and the time when the output voltage V_{OUT} reaches the on-level V_{ON} is the time-to-light or delay time. By virtue of pre-charging the output capacitor 13 during the initialization phase this delay time TEL is shorter than an delay that would occur if the lamp drive circuit would generate the output current I_{OUT} with the lamp drive level I_{LD} right from the beginning of the on-phase. An increase of the output voltage V_{OUT} in this case is illustrated in dotted lines in FIG. 2; t3, which is after t2, denotes the end of the delay time in this case.

In order to prevent the LEDs Z₁-Zₙ from being damaged or from flashing up brighter than desired, it is desirable for the initialization phase T_{INIT} to end before the output voltage V_{OUT} reaches the on-level V_{ON}. This is illustrated in FIG. 2 in that the initialization phase T_{INIT} ends at time t1 which is before time t2 when the output voltage V_{OUT} reaches the on-level. Causing the initialization phase T_{INIT} to end before the output voltage V_{OUT} reaches the on-level V_{ON} is obtained by controlling the initialization phase based on an initialization value, wherein the initialization value is dependent on the voltage level of the output voltage V_{OUT} in a preceding on-phase. Referring to FIG. 1, the lamp drive circuit includes a memory 3 coupled to the power converter 2 and configured to store this initialization value. The initialization value may be dependent on the on-level V_{ON} the output voltage reaches during the lamp drive phase of the preceding on-phase. This is based on the assumption that the LED circuit Z does not change during the off-phases between the individual on-phases so that the on-level V_{ON} is essentially the same in each on-phase. Slight variations of the on-level V_{ON} may result from different load drive levels I_{LD} of the output current I_{OUT}, that is, from differently dimming the LEDs Z₁-Zₙ in different on-phases. Such variations, however, can be considered by suitably controlling the initialization phase, as further detailed below.

Referring to FIG. 2, controlling the initialization phase may include detecting the output voltage V_{OUT} and terminating the initialization phase when the output voltage V_{OUT} reaches a pre-charge level V_{PRE}, wherein the pre-charge level V_{PRE} is dependent on the initialization value. Referring to the above, the initialization value represents the on-level V_{ON} of the output voltage V_{OUT} in a preceding on-phase. In order to prevent the output voltage V_{OUT} from reaching the on-level during the initialization phase, the pre-charge level V_{PRE} is lower than the on-level V_{ON} represented by the initialization value. According to one example, the pre-charge level V_{PRE} is selected from between 60% and 90%, in particular between 65% and 80% of the on-level represented by the initialization value.

The method explained above, is illustrated in FIG. 3. FIG. 3 illustrates method steps performed by the power converter 2 in two different on-phases 110, 120. Referring to FIG. 3, operation of the power converter 2 in an earlier one 110 of these on-phases 110, 120 includes a detection and storage process 111 in which an initialization value M(k−m) is stored in the memory 3. The initialization value M(k−m) is dependent on a voltage level of the output voltage V_{OUT} in the on-phase 110. In particular, the initialization value M(k−m) is dependent on the on-level V_{ON} in the on-phase 110. This on-level is referred to as V_{ON}(k−m) in the following. According to one example, the initialization value M(k−m) is proportional to the on-level V_{ON}(k−m). Referring to the above, the output voltage V_{OUT} reaches the on-level V_{ON} after a delay time TEL after the beginning of the respective on-phase. Detecting the on-level V_{ON}(m−k) in the earlier on-phase 110 may include detecting the output voltage V_{OUT} after a fixed delay time after the beginning of the on-phase 110. This delay time is selected such that, under normal circumstances, the output voltage V_{OUT} has definitely reached the on-level V_{ON} after this delay time. According to one example, the delay time is selected from a range of between 2 seconds and 10 seconds. According to another example, the power converter 2 is configured to detect the on-level V_{ON}(m−k) by measuring the output voltage V_{OUT} at the time when the input signal S_{IN} changes from the on-level to the off-level at the end of the on-phase.

Referring to FIG. 3, the method further includes in an on-phase 120 that succeeds the earlier on-phase 110 a control process 130 that controls the initialization phase in the succeeding on-phase 120 based on the initialization value M(k−m) stored in the memory 3. After the initialization phase in on-phase 120, the power converter circuit 2 enters the load drive phase 140 in which the output current I_{OUT} is regulated either based on a fixed value stored in the power converter 2 or based on the dimming signal S_{DIM}.

Referring to the above, on-phase 120 succeeds on-phase 110. This includes either that the later on-phase 120 directly succeeds the earlier on-phase 110 so that there is only one off-phase between these two on-phases 110, 120, or that the later on-phase 120 does not directly succeed the earlier on-phase 110 so that there is at least one further on-phase (and there are at least two off-phases) between these on-phases. According to one example, the power converter 2 is configured to store an initialization value M in each on-phase and the initialization value stored in one on-phase is used in the directly succeeding on-phase to control the initialization phase. According to another example, the power converter is configured to use an initialization value M stored in one on-phase to control the initialization phases in several succeeding on-phases before a new initialization value is stored and again used in several on-phase to control the initialization phase.

Referring to the above, controlling the initialization phase may include detecting the output voltage V_{OUT}, comparing a voltage level of the detected output voltage V_{OUT} with a pre-charge level V_{PRE}, and end the initialization phase and begin the load drive phase when the output voltage level equals the pre-charge level V_{PRE}. Referring to the above, the pre-charge level V_{PRE} in one on-phase, such as on-phase 120 shown in FIG. 3, is dependent on the initialization value M(k−m) stored in a preceding on-phase, such as on-phase 110 shown in FIG. 3, wherein the initialization value M(k−m) is dependent on the on-level in the preceding on-phase. The pre-charge level V_{PRE} used in on-phase 120 is referred to as V_{PRE}(k) in the following. In general,

V_{PRE}(k)=c₁·V_{ON}(k−m) (1),

where c₁ is a constant that, for example, is selected from a range of between 0.6 and 0.9, in particular between 0.7 and 0.8. The initialization value M(k−m) stored in the memory 3 in one on-phase may be obtained based on the on-level V_{ON}(k−m) in this on-phase in several ways. Consequently, the pre-charge level V_{PRE}(k) used in a succeeding on-phase may be obtained based on the stored initialization value M(k−m) in several ways. According to one example, the stored initialization value M(k−m) equals V_{ON}(k−m) so that

M(k−m)=V_{ON}(k−m) (2a).

In this case, the power converter 2 calculates the pre-charge level V_{PRE}(k) based on equation (1). According to another example, the power converter 2 is configured to store the initialization value M(k−m) such that it equals the pre-charge level V_{PRE}(k−m), so that

M(k−m)=c₁·V_{ON}(k−m)=V_{PRE}(k) (2b).

According to yet another example, the power converter 2 is configured to store initialization M(k−m) such that it is different from, but proportional to the on-level V_{ON}(k−m) in on-phase 110, and the power converter in a succeeding on-phase uses a pre-charge level V_{PRE}(k) that is different from, but proportional to the stored initialization value M(k−m), so that,

M(k−m)=c₂·V_{ON}(k−m) (3a),

V_{PRE}(k)=c₃·V_{ON}(k−m) (3b),

where each of c₂ and c₃ is a constant that are selected such that c₂ multiplied by c₃ equals c₁, that is,

c₂·c₃=c₁ (4).

In a very first on-phase there are various ways for the lamp drive circuit to operate. The “very first on-phase” is an on-phase that has no preceding on-phase in which an initialization value has been stored in the memory 3. According to one example, a very first initialization value is stored in the memory 3 by the manufacturer of the lamp drive circuit and this very first initialization value is used to control the initialization phase in the very first on-phase. According to another example, the memory 3 has a programming interface (not shown in FIG. 1) via which the very first initialization value can be written into the memory 3 at the installation site, by an electrician, for instance. This very first initialization value stored in the memory 3 at the installation site may take into account the specific type of LED circuit connected to the lamp drive circuit at the installation site. The very first initialization value may, for example, take into account the number of LEDs connected in series in the LED circuit.

FIG. 4 shows a flow chart that illustrates one example of the initialization phase 130 shown in FIG. 3 in greater detail. Referring to FIG. 4, the initialization phase 130 includes detecting the input signal S_{IN} in a detection step 131 and a pre-charge step 132 in which the output capacitor 13 is pre-charged. The pre-charging 132 begins when an on-level of the input signal S_{IN} in the detection step 130 is detected by the power converter 2. Pre-charging the output capacitor 13 ends and the load drive phase 140 starts when in another detection step 133 it is detected that the output voltage level has reached the pre-charge level V_{PRE}.

A modification of the initialization phase 130 shown in FIG. 4 is shown in FIG. 5. In the example shown in FIG. 5 the initialization phase includes a further detection step 134 that detects a duration of the initialization phase and ends the initialization phase when the output voltage level has not reached the pre-charge level within a predefined time threshold T_{TH}. This may occur, for example, if the LED circuit is replaced during the off-time by another LED circuit that includes less LEDs connected in series and, therefore, has a lower on-voltage V_{ON}.

One example of the power converter 2 is shown in FIG. 6. In this example, the power converter 2 is implemented with a flyback-converter topology and includes a transformer 21 with a primary winding 21₁ and a secondary winding 21₂ that is inductively coupled with the primary winding 21₁. The primary winding 21₁ is connected in series with an electronic switch 23, wherein a series circuit with the primary winding 21₁ and the electronic switch 23 is connected between the input nodes 14, 15. The electronic switch 23 is, for example, a transistor. In the example shown in FIG. 6, the transistor is drawn as an n-type enhancement MOSFET. This, however, is only an example. Any other type of transistor such as another type of MOSFET (p-type enhancement MOSFET, p-type depletion MOSFET, n-type depletion MOSFET), a Bipolar Junction Transistor (BJT), a JFET (Junction Field-Effect Transistor) or a HEMT (High Electron Mobility Transistor) such as a GaN HEMT may be used as well. A controller 24 drives the electronic switch 23 based on a drive signal S_{DRV}. The controller 24 receives the input signal S_{IN} and the optional dim signal S_{DIM} and is configured to write the initialization value into the memory 3 and receive the stored initialization value from the memory 3.

Although the memory 3 is drawn outside the power converter 2 in the examples shown in FIGS. 1 and 6, the memory 3 is not necessarily physically outside the power converter 2. According to one example, memory 3 is indeed an external memory device outside the power converter 2 and the controller 24 of the power converter 2. According to another example, however, the memory 3 is integrated in the power converter controller 24. The optional programming interface of the memory 3 is not shown in FIGS. 1 and 6.

Referring to FIG. 6, the output 11, 12 and the output capacitor 13 are coupled to the secondary winding 21₂. According to one example, a rectifier element 22 such as a diode is connected in series with the secondary winding 21₂, and the output capacitor 13 is connected in parallel with a series circuit that includes the secondary winding 21₂ and the rectifier element 22. The controller 24 is configured to regulate an average of the output current I_{OUT} based on a switched-mode operation of the electronic switch 23. The output current I_{OUT} is a current through the series circuit with the secondary winding 21₂ and the diode 22. The controller 24 is further configured to detect the output voltage V_{OUT} in order to control the initialization phase as explained before. One example of how the controller 24 may detect the output voltage V_{OUT} and regulate the output current I_{OUT} is explained in the following.

FIG. 7 shows a power converter 2 that is based on the power converter shown in FIG. 6 and that additionally includes an auxiliary winding 21₃ inductively coupled with the primary winding 21₁ and the secondary winding 21₂. A voltage across the auxiliary winding 21₃ is referred to as auxiliary voltage V_{AUX} in the following. In this example, the controller 24 receives an auxiliary signal S_{AUX} which, according to one example, is essentially proportional to the auxiliary voltage V_{AUX}. In the example shown in FIG. 7, the auxiliary signal S_{AUX} is generated from the auxiliary voltage V_{AUX} by a voltage divider circuit 26 that includes a resistive voltage divider with a first resistor 261 and a second resistor 262. The auxiliary signal S_{AUX} is a voltage across the second resistor 262. Optionally, a capacitor 263 is connected in parallel with the second resistor 262. This capacitor 263 serves to filter undesired voltage spikes of the auxiliary signal S_{AUX}.

Optionally, a supply circuit 25 receives the auxiliary voltage V_{AUX} and generates a supply voltage V_{CC} for the controller 24. The supply circuit 25 may include a rectifier circuit that rectifies the auxiliary voltage V_{AUX}. In the example shown in FIG. 7, the supply circuit includes a series circuit with a capacitor 251 and a rectifier element 252, such as a diode, wherein this series circuit is connected in parallel with the auxiliary winding 21₃. The supply voltage V_{CC} of the controller 24 is available across the capacitor 251. Optionally, a resistor 253 is connected in series with the rectifier element 252. This supply circuit 25 generates the supply voltage V_{CC} during the switched-mode operation of the electronic switch 23. In order to supply the controller 24 at the beginning of the on-phase, that is, before the electronic switch 23 has been switched on for the first time in each on-phase, the controller 24 may additionally receive the input voltage V_{IN} (as illustrated in dotted lines in FIG. 7).

Referring to FIG. 7, the controller 24 further receives a current sense signal CS that represents a current I₁ through the primary winding 21₁ and the electronic switch 23. In the example shown in FIG. 7, the current sense signal CS is a voltage across a sense resistor 24 connected in series with the electronic switch 23. This, however, is only an example. Instead of the sense resistor 24 any other type of current sensor configured to sense the current through the electronic switch 23 may be used to generate the current sense signal CS as well.

One example of the controller 24 is shown in FIG. 8. FIG. 8 shows a block diagram of the controller 24. It should be noted that this block diagram illustrates the functional blocks of the controller 24 rather than a specific implementation. Those functional blocks can be implemented in various ways. According to one example, these functional blocks are implemented using dedicated circuitry. According to another example, the controller 24 is implemented using hardware and software.

Referring to FIG. 8, the controller 24 includes an operation phase controller 241 that controls the individual operation phases of the power converter 2. That is, the operation phase controller 41 controls the on-phases and off-phases and, within the on-phases, the initialization phase and the load drive phase. The operation phase controller 241 receives the input signal S_{IN} and the auxiliary signal S_{AUX} and is configured to store the initialization value in the memory 3 and receive the initialization value from the memory 3. Referring to the above, the power converter 2 is configured to regulate the output current I_{OUT} during the on-phase wherein, according to one example, in the initialization phase a current level of the output current I_{OUT} is regulated to have a pre-charge level and in the load drive phase is regulated to have a current level that is either fixed or defined by the dimming signal S_{DIM}. Regulating the output current I_{OUT} requires detecting the output current I_{OUT}. The controller 24 shown in FIG. 8 includes an output current detector 242 that is configured to detect a current level of the output current dependent on the auxiliary signal S_{AUX} and the current sense signal CS. A current signal S_{IOUT} provided by the output current detector 242 represents an average current level of the output current I_{OUT}. An error filter 242 receives the current signal S_{IOUT} and a set signal S_{SET}, wherein the set signal S_{SET} represents a desired average current level of the output current I_{OUT}.

The set signal S_{SET} is provided by a multiplexer 243 which, controlled by the operation phase controller 241, outputs the dim signal S_{DIM} or a pre-charge signal S_{PRE} as the set signal S_{SET}. The multiplexer 243 is controlled by the operation phase controller 241 such that during the initialization phase the pre-charge signal S_{PRE} is output as the set signal S_{SET} and during the load drive phase either a fixed signal or the dim signal S_{DIM} is output as the set signal S_{SET}. The pre-charge signal S_{PRE} represents a desired average current level of the output current I_{OUT} during the initialization phase. The error filter 244 generates an error signal S_{ERR} based on the output current signal S_{IOUT} and the set signal S_{SET}. According to one example, the error filter 244 calculates a difference between the output current signal S_{IOUT} and the set signal S_{SET} and filters the difference in order to generate the error signal S_{ERR}. In one example. the filter has one of a proportional (P), integrative (I), proportional-integrative (PI) or proportional-integrative-derivative (PID) characteristic. In another example, the filter has another type of transfer function, e.g., a non-linear transfer function obtained by using one or more non-linear filters in the error filter 244. A pulse-width modulator (PWM) 245 receives the error signal S_{ERR} and generates a pulse-width modulated drive signal S_{DRV} based on the error signal S_{ERR}. Optionally, a driver 246 is connected between the PWM 245 and the electronic switch 23 (the latter is not shown in FIG. 8). The driver 246 is configured to generate a drive signal level suitable to drive the electronic switch 23 based on the pulse-width modulated output signal of the PWM 245. Referring to FIG. 8, the operation phase controller further controls the pulse-width modulator 245 such that the pulse-width modulator 245 outputs the drive signal S_{DRV} based on the error signal S_{ERR} only during the on-phase and generates an output signal that keeps the electronic switch 23 in the off-state during the off-phase.

An example of how the output current detector 242 may detect (calculate) the output current signal S_{IOUT} based on the current sense signal CS and the auxiliary signal S_{AUX} and of how the operation phase controller 241 may detect the output voltage V_{OUT} based on the auxiliary signal S_{AUX} is explained with reference to FIG. 9.

FIG. 9 shows timing diagrams of the auxiliary voltage V_{AUX}, a primary current I₁ and a secondary current I₂ and the drive signal S_{DRV} during one drive cycle of the electronic switch 13. A duration of this drive cycle is referred to as T_{CYCLE} in FIG. 9. One drive cycle includes an on-period T_{ON} in which the drive signal S_{DRV} switches on the electronic switch 13 and an off-period T_{OFF} in which the drive signal S_{DRV} switches off the electronic switch 13. The primary current I₁ is a current through the primary winding 21₁ of the transformer 21 and the secondary winding 12 is a current through the secondary winding 21₂. During the on-period T_{ON} a voltage V1 across the primary winding 21₁ essentially equals the input voltage V_{IN} (when a voltage drop across the electronic switch 23 is neglected). As illustrated in FIG. 9, the primary current I₁ increases essentially linearly during the on-period T_{ON}. A slope of the primary current increase is approximately given by V_{IN}/L, where V_{IN} is the input voltage and L is an inductance of the transformer 21. During the on-period, the secondary current I₂ is zero, which is due to the fact that the primary winding 21₁ and the secondary winding 21₂ have opposite winding senses and the rectifier element 22 allows the current through the secondary winding 21₂ to flow only in one direction. During the on-period, the transformer 21 is magnetized and during the off-period T_{OFF} the transformer 21 is demagnetized. During the off-period T_{OFF} there is a demagnetization period T_{DEMAG} during which the secondary current I₂ is different from zero. This secondary current I₂ decreases essentially linearly beginning with a peak current level I₂_{_}_{PEAK} at the beginning of the off-period T_{OFF}. According to one example, the power converter 2 operates such that the transformer 21 is completely demagnetized during the off-period. That is, the secondary current I₂ decreases to zero during the off-period before the electronic switch 13 again switches on at the beginning of a next drive cycle. In general, an average level I_{AVG}_{_}_{OUT} of the output current I_{OUT} during one drive cycle is given by:

$${I}_{OUT\_AVG} = \frac{1}{{T}_{CYCLE}} \cdot {\int }_{0}^{{T}_{CYCLE}} {I}_{2} dt . \qquad ( 5 )$$

Referring to the above, the secondary current I₂ decreases substantially linearly during the demagnetization period T_{DEMAG} so that in this case, the average output current I_{OUT}_{_}_{AVG} is given by

$${I}_{OUT\_AVG} = \frac{{I}_{2 \_PEAK} \cdot {T}_{DEMAG}}{2 \cdot {T}_{CYCLE}} . \qquad ( 6 )$$

The output current detector 242 is configured to detect the average output current I_{OUT}_{_}_{AvG} based on equation (6) and output the current signal S_{IOUT} based on this detection. Referring to equation (6) detecting the average output current I_{OUT}_{_{—AvG}} may include detecting the peak level I₂_{_}_{PEAK} of the secondary current I₂, detecting the cycle time T_{CYCLE} and the demagnetization time T_{DEMAG}.

According to one example, the output current detector 242 is configured to detect the peak level I₂_{_}_{PEAK} of the secondary current I₂ based on the peak level I₁_{_}_{PEAK} of the primary current I₁. The current sense signal CS received by the output current detector 242 represents the primary current I₁. The output current detector 242 is configured to sample the current sense signal CS at a first sample time t_{S1}, which is the time when the drive signal S_{DRV} switches off the electronic switch 13. At this first sample time t_{S1} the current sense signal CS represents the peak level I₁_{_}_{PEAK} of the primary current I₁. The output current detector 242 receives the drive signal S_{DRV} and samples the current sense signal CS when the signal level of the drive signal S_{DRV} changes from the on-level that switches on the electronic switch 13 to an off-level that switches off the electronic switch 13 in order to obtain the peak level I₁_{_}_{PEAK} of the primary current I₁. The peak level I₂_{_}_{PEAK} of the secondary current I₂ is proportional to the peak level I₁_{_}_{PEAK} as follows:

$${I}_{2 \_PEAK} = {I}_{1 \_PEAK} \cdot \frac{{N}_{1}}{{N}_{2}} , \qquad ( 7 )$$

where N₁ denotes the number of turns of the primary winding 21₁ and N₂ denotes the number of turns of the secondary winding 21₂. According to one example, the output current controller 242 is configured to obtain the secondary peak current level I₂_{_}_{PEAK} based on equation (7).

The output current detector 242 is further configured to detect the end of the demagnetization period T_{DEMAG} based on the auxiliary signal S_{AUX}. The demagnetization period T_{DEMAG} is given by a time difference between the detected end of the demagnetization period and the beginning of the off-period T_{OFF} and is calculated by the output current detector 242 based on this relationship. Referring to the above, the drive signal S_{DRV} received by the output current detector 242 indicates the beginning of the off-period, so that the output current detector 242 obtains this information from the drive signal S_{DRV}. Further, the output current detector is configured to detect the end of the demagnetization period T_{DEMAG} based on the auxiliary signal S_{AUX} as explained below.

The auxiliary voltage V_{AUX} starts to oscillate after the end of the demagnetization period T_{DEMAG}. This is illustrated in FIG. 9 in which the beginning of one oscillation period is shown. In the example shown in FIG. 9, however, the electronic switch based on the drive signal S_{DRV} is switched on when a first local minimum of the oscillation occurs so that only one section of a first oscillation period is shown in FIG. 9. Those oscillations result from the inductance of the transformer 21 and a parasitic capacitance such as an output capacitance of the electronic switch 23. According to one example, the output current detector 242 detects a time instant when the auxiliary voltage V_{AUX} and, therefore, the auxiliary signal S_{AUX} reaches zero for the first time after the beginning of the off-period. This time is referred to as first zero crossing time in the following. Further, the output current detector 242 is configured to calculate the duration of the demagnetization period T_{DEMAG} as a time difference between the first zero crossing time and the beginning of the off-period minus a delay time, wherein the delay time represents a duration between the end of the demagnetization period T_{DEMAG} and the first zero crossing time. This delay time is about one quarter (¼) of one oscillation period so that according to one example, the output current detector subtracts one quarter of the oscillation period from the time difference between the first zero crossing time and the beginning of the off-period in order to obtain the demagnetization period T_{DEMAG}.

A frequency and, therefore, a duration of one period of the oscillation may be calculated or measured during or at the end of the manufacturing process and a value representing one quarter of the oscillation period may be stored in the output current detector 242. Based on this stored value and the detected time difference between the first zero crossing time and the beginning of the off-period the output current detector 242 may obtain the demagnetization period T_{DEMAG}. Of course, the value representing one quarter of the oscillation period may be stored anywhere in the control circuit 24, such as in the operation phase controller 241, and retrieved by the output current detector 242 from wherever it is stored. According to another example, the control circuit 24 is configured to measure the duration of one oscillation period and use the measured oscillation period in the detection of the duration of the demagnetization period T_{DEMAG}. Measuring the oscillation period may include operating the power converter such that in one drive period the electronic switch 23 is not switched on when a first local minimum of the auxiliary voltage V_{AUX} (the auxiliary signal S_{AUX}) occurs after the beginning of the off-period, but when a second or third local minimum occurs, and measuring a time difference between two successive zero crossing times. This time difference represents one half (½) of the oscillation period.

According to one example, the pulse-width modulator 245 is configured to switch on the electronic switch 13 at a fixed frequency so that the individual drive cycles have the same duration, that is, T_{CYCLE}=1/f, where f is the switching frequency. According to another example, the power converter 2 operates in a quasi-resonant (QR) mode. In this case, as explained above, a new drive cycle starts each time the auxiliary voltage V_{AUX} after the end of the demagnetization period T_{DEMAG} reaches a local minimum (valley). In this case, the pulse-width modulator also receives the auxiliary signal S_{AUX} in order to detect those local minima. According to one example, detecting the local minima includes detecting zero crossing times when the auxiliary signal S_{AUX} decreases and starting a new drive cycle one quarter of the oscillation period after a zero crossing time. According to one example, as shown in FIG. 9, a new drive cycle starts when the first local minimum in the off-period occurs. The information about the duration of one quarter of the oscillation period may be obtained as explained above, that is, during the manufacturing process or by measuring during the operation, for example. In one example, the pulse-width modulator adjusts the duration T_{ON} of the on-period based on the error signal S_{ERR} in order to regulate the average output current I_{OUT}. In another example, the driver adjusts a peak current based on the error signal S_{ERR}. In this example, the controller 24 may compare the current sense signal CS with a peak-current threshold and switch off the electronic switch 23 when the current sense signal reaches the peak-current threshold. The duration T_{ON} of the on-period is the given by the time duration between switching on the electronic switch 23 and the time when the current sense signal CS reaches the peak-current threshold.

Further, the operation phase controller 241 detects the output voltage V_{OUT} based on the auxiliary voltage V_{AUX}. According to one example, the operation phase controller 241 samples the auxiliary voltage V_{AUX} at a second sample time tₛ₂, which is the time when the demagnetization period T_{DEMAG} ends. At this second sample time tₛ₂ the auxiliary voltage V_{AUX} is proportional to the output voltage V_{OUT} and is given by

$${V}_{AUX} = {V}_{OUT} \cdot \frac{{N}_{3}}{{N}_{2}} , \qquad ( 7 )$$

where N₃ is the number of turns of the auxiliary winding 21₃ and N₂ is the number of turns of the secondary winding 21₂.

FIG. 10 shows a power converter according to another example. This power converter is different from the power converter shown in FIGS. 6 and 7 in that the secondary winding 21₂ is omitted and the circuit that is connected in parallel with the secondary winding 21₂ in the examples shown in FIGS. 6 and 7 is connected in parallel with the primary winding in the example shown in FIG. 10. That is, a series circuit that includes the rectifier element 22 and the parallel circuit with the output capacitor 13 and the load Z is connected in parallel with the primary winding 21₁. This power converter operates in the same way as the power converter shown in FIG. 7. That is, during the on-phase the electronic switch connected in series with the primary winding is switched on and off in a PWM fashion in a plurality of drive cycles, In the on-period of each drive cycle the transformer 21 is magnetized and the output current I_{OUT} is zero. The output current I_{OUT} is the current through the circuit connected in parallel with the primary winding 21₁. In the off-period of each drive cycle the transformer is demagnetized and an output current I_{OUT} different from zero flows through the series circuit. The output current I_{OUT} and an average of the output current can be detected in the same way as explained before, that is, by detecting the peak current level of the current through the primary winding 21₁ and detecting the duration of the demagnetization period. The latter is detected using the auxiliary winding 21₃.

1. A drive circuit, comprising:
output nodes configured to be coupled to a load;
a capacitor coupled between the output nodes; and
a power converter,
wherein the power converter is configured to store an initialization value in a memory in at least one of a plurality of on-phases of the drive circuit and to control an initialization phase of at least one other of the plurality of on-phases based on the initialization value stored in the memory,
wherein the initialization value is dependent on an output voltage across the capacitor during a load drive phase of the at least one on-phase, and
wherein the power converter is further configured to regulate an output current during the load drive phase.

2. The drive circuit of claim 1, wherein the power converter is further configured to operate the drive circuit in the plurality of on-phases based on an input signal received by the power converter.

3. The drive circuit of claim 1, wherein the power converter is configured to regulate the output current based on a dimming signal received by the power converter.

4. The drive circuit of claim 1,
wherein the power converter is configured to store the initialization value dependent on the a voltage across the capacitor during the load drive phase of each of the plurality of on-phases.

5. The drive circuit of claim 4,
wherein the power converter is configured to control the initialization phase based on the initialization value stored in the memory in each of the plurality of on-phase.

6. The drive circuit of claim 4,
wherein the plurality of on-phases comprise a first on-phase, and
wherein the power converter is configured to control the initialization phase of the first on-phase based on a predefined initialization value.

7. The drive circuit of claim 6, wherein the predefined initialization value is stored in the memory.

8. The drive circuit of claim 1,
wherein the power converter is configured, in the initialization phase, to control the output current to be higher than in the load drive phase directly succeeding the initialization phase.

9. The drive circuit of claim 8,
wherein the power converter is configured, in the initialization phase, to control the output current independent of the dim signal.

10. The drive circuit of claim 1, wherein the power converter, in the initialization phase of the at least one other on-phase, is configured
to detect the output voltage; and
stop the initialization phase and start the load drive phase when the detected output voltage reaches a voltage level that is dependent on the initialization value stored in the memory.

11. The drive circuit of claim 10, wherein the power converter is configured,
in the load drive phase of the at least one on-phase, to store the initialization value such that it is proportional to a voltage level of the detected output voltage, and
in the at least one other on-phase, to stop the initialization phase when a voltage level of the detected output voltage reaches a stop level that is proportional to the initialization value stored in the memory.

12. The drive circuit of claim 11, wherein
the initialization value equals the voltage level of the detected output voltage and
the stop level is lower than a voltage level represented by the initialization value.

13. The drive circuit of claim 12, wherein the stop level is less than 100% of the voltage level represented by the initialization value.

14. The drive circuit of claim 11, wherein
the initialization value is lower than the voltage level of the detected output voltage; and
the stop level equals the voltage level represented by the initialization value.

15. The drive circuit of claim 14, wherein the initialization value is less than 90% of the voltage level of the detected output voltage.

16. The drive circuit of claim 10, wherein the power converter is further configured to detect a duration of the initialization phase and stop the initialization phase when the duration reaches a time threshold.

17. The drive circuit of claim 16, wherein the time threshold is dependent on the initialization value stored in the memory.

18. The drive circuit of claim 10, wherein the power converter comprises:
a transformer with a primary winding and a secondary winding,
wherein the secondary winding is coupled to the load nodes

19. The drive circuit of any of claim 10,
wherein the power converter comprises a transformer with a primary winding,
wherein the primary winding is coupled to the load nodes.

20. The drive circuit of claim 18, wherein the power converter further comprises:
an electronic switch connected in series with the primary winding, and
a controller configured to drive the electronic switch,
wherein a series circuit comprising the primary winding and the electronic switch is coupled to an input configured to receive an input power, and
wherein the controller is configured, in each of the plurality of on-phases, to drive the electronic switch in a plurality of successive drive cycles each comprising an on-time in which the electronic switch is switched on and an off-time in which the electronic switch is switched on.

21. The drive circuit of claim 20,
wherein the controller is configured to regulate the output current at least by adjusting a duration of the on-time or adjusting a peak-current threshold.

22. The drive circuit of claim 21,
wherein the controller is further configured to detect the output current and generate an error signal based on the detected output current, and
wherein the controller is configured to adjust the duration of the on-time based on the error signal.

23. The drive circuit of claim 22,
wherein the controller is configured to detect the output current based on a current through the primary winding during the on-time and a voltage across an auxiliary winding during the off-time.

24. The drive circuit of claim 20, wherein the controller is configured to detect the output voltage based on a voltage across an auxiliary winding.

25. A method, comprising:
in at least one of a plurality of on-phases of a drive circuit storing an initialization value in a memory;
controlling an initialization phase of the drive circuit during at least one other of the plurality of on-phases based on the initialization value stored in the memory; and
regulating an output current during the at least one other on-phase after the initialization phase,
wherein the initialization value is dependent on an output voltage across an output capacitor of the drive circuit during a load drive phase of the at least one on-phase.

26. The method of claim 25, further comprising:
operating the drive circuit in the plurality of on-phases based on an input signal received by the drive circuit.

27. The method of claim 25, wherein regulating the output current comprises regulating the output current based on a dimming signal received by the drive circuit.

28. The method of claim 25, wherein storing the initialization value comprises storing the initialization dependent on the a voltage across the capacitor during the load drive phase of each of the plurality of on-phases.

29. The method of claim 28, wherein controlling the initialization phase comprises controlling the initialization phase based on the initialization value stored in the memory in each of the plurality of on-phase.

30. The method of claim 28,
wherein the plurality of on-phases comprise a first on-phase, and
wherein the initialization phase of the first on-phase is controlled based on a predefined initialization value.

31. The method of claim 30, wherein the predefined initialization value is stored in the memory.
